(19) United States
(12) Patent Application Publication
(10) Pub. No.: US 2004/0078985 A1
(43) Pub. Date: Apr. 29, 2004

(54) Multi-functional cutting unit

(76) Inventor: Jingjing Chen, Jingmen City (CN)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/655,268

(22) Filed: Sep. 4, 2003

(30) Foreign Application Priority Data
Sep. 9, 2002 (CN) 02 2 73100.8
Sep. 29, 2002 (CN) 02 1 47625.X

(51) Int. Cl. B26B 19/14

(52) U.S. Cl. 30/346.51; 30/43.6

(57) ABSTRACT

The present invention provides a cutting unit which comprises a circular cutter chassis having a coupling aperture provided at the center thereof, a plurality of cutting members evenly distributed along the circumference of the cutter chassis each of which comprises a pedestal disposed at the circumference of the cutter chassis having a first inclined plane extended upward from the cutter chassis and a second inclined plane extended outward from the cutter chassis, and a cutter connected to the first inclined plane and being perpendicular to the first inclined, and having an inner blade element and an outer blade element relative to the center of the cutter chassis. The top surfaces of the inner blade element and the outer blade element are in a square-shape and positioned on a same plane. The cutting unit of the invention is of a better elasticity and the efficiency than that in the prior art, and difficult to be damaged.

### BACKGROUND OF THE INVENTION

1. Field of the Invention

The present invention generally relates to a cutter for shaving, and more particularly to a multi-functional cutting unit that may be used for shaving of whiskers in an electric dry-shaver, and for stirring and breaking food, as well as for milling and drilling.

2. Description of the Related Art

Currently, the inner cutter of an electric dry-shaver is mainly driven by a motor mounted within the housing of the shaver. The rotating inner cutter is engaged with the interior surface of the outer cutter. As a result, whiskers entered into the outer cutter will be cut off by the shearing force caused therebetween. Such an electric shaver has been disclosed in U.S. Pat. No. 6,199,282 (Uchiyama et al). The electric shaver in this patent has one or more circular outer cutter units, and each of them is provided with a plurality of annular blade formation regions arranged concentrically. While the circular inner cutter unit rotates, it is engaged to the annular blade formation regions. Disadvantages of the electric shaver are as follows. Firstly, straightly-positioned cutter heads of the inner cutter rigidly engage the outer blade formation regions when the shaver works, and when the whiskers are forcibly shaved, the thinner outer cutter units tend to be distorted and be abraded until the blades are broken. Moreover, a space where the whiskers may be clipped will be formed between the inner cutter and the outer cutter in case of the distortion. Secondly, because one cutter head of the inner cutter has only two blades in the circumferential direction, the efficiency of shaving of whiskers is lower. Thirdly, the longer whiskers shaved and remained on the inner cutters tend to enwind the shaft of the cutter head, and the whiskers cannot be smashed and removed, which will definitely increase power consumption. Cutter heads for stirring and breaking food having typically centrifugal foils in the art have the shortcomings similar to those mentioned above for the shaver.

Hence, the present invention provides a cutting unit that overcomes the aforementioned problems in the art.

### SUMMARY OF THE INVENTION

Accordingly, an object of the present invention is to provide a cutting unit which can be used not only for the dry-shaver but also for stirring and breaking food, as well as for milling and drilling.

In order to achieve the above-mentioned object, a cutting unit in accordance with the present invention comprises a circular cutter chassis having a coupling aperture provided at the center thereof, a plurality of cutting members evenly distributed along the circumference of the cutter chassis, each of which comprises a pedestal disposed at the circumference of the cutter chassis having a first inclined plane extended upward from the cutter chassis and a second inclined plane extended outward from the cutter chassis, and a cutter connected to the first inclined plane and being perpendicular to the first inclined, and having an inner blade element and an outer blade element relative to the center of the cutter chassis. The top surfaces of the inner blade element and the outer blade element are in a square-shape and positioned on a same plane.

In one embodiment of the present invention, each of the inner blade element and the outer blade element has a blade plane which is disposed at the upper side thereof and parallel to the top surface thereof. And the inner blade element and the outer blade element may form a U-configuration and two fringes are formed at the joint thereof.

In another embodiment of the invention, a gap having an edge is provided at the upper joint of the pedestal and the cutter.

In a preferred embodiment in accordance with the present invention, the first inclined plane is disposed at an angle of 75° to less than 90° with the plane the cutter chassis locates. The second inclined plane forms an angle of more than 90° to 95° with the plane the cutter chassis locates.

Also, the number of the cutting members in the present invention may be from 6 to 12. The distance between the central lines of the inner blade element and the outer blade element in the longitudinal direction is from 2 to 4 mm, and both the length and width of each of the top surfaces of the inner blade elements and the outer blade elements are from 0.8 to 1 mm. The blade plane has a width of 0.1 to 0.5 mm in the circular direction, a depth of 0.1 to 0.5 mm in the longitudinal direction with respect to the top surface, and a length of 0.8 to 1 mm. The diameter of the gap is from 0.4 to 0.6 mm. The distance between the central lines of the cutting member and the cutter chassis in the longitudinal direction is from 4 to 10 mm, and the diameter of the cutter chassis is from 6 to 15 mm.

According to the above-mentioned technical solutions of the present invention, the pedestal and the cutter are substantially inclined. As a result, the cutting unit of the invention is of a better elasticity than that in the prior art. Therefore, the cutting unit can fully contact the outer cutter and be difficult to be damaged. Moreover, the efficiency of the shaving is improved because of the increasing amount of the edges, and, the gap provided at the joint of the pedestal and the cutter benefits to cut long whiskers enwinding around the cutter chassis.

Other objects, features and advantages of the present invention will become apparent from the following detailed description in conjunction with the accompanying drawings.

### BRIEF DESCRIPTION OF THE DRAWINGS

FIG. 1 is a schematic perspective view of one embodiment of the cutting unit in accordance with the present invention;

FIG. 2 is a front view of the cutting unit as shown in FIG. 1;

FIG. 3 is a schematic view illustrating the relationship between a first inclined plane and a second inclined plane of the pedestal and the cutter chassis as shown in FIG. 1;

FIG. 4 is a partially enlarged schematic view illustrating the relationship between a blade plane and an inner blade member of the cutting unit of the invention; and

FIG. 5 is a partially enlarged schematic view of a gap of the pedestal of the cutting unit of the invention as shown in FIG. 1.

### DETAILED DESCRIPTION OF PREFERRED EMBODIMENTS OF THE INVENTION

The present invention will be further described below with reference to the drawings.

### EXAMPLE 1

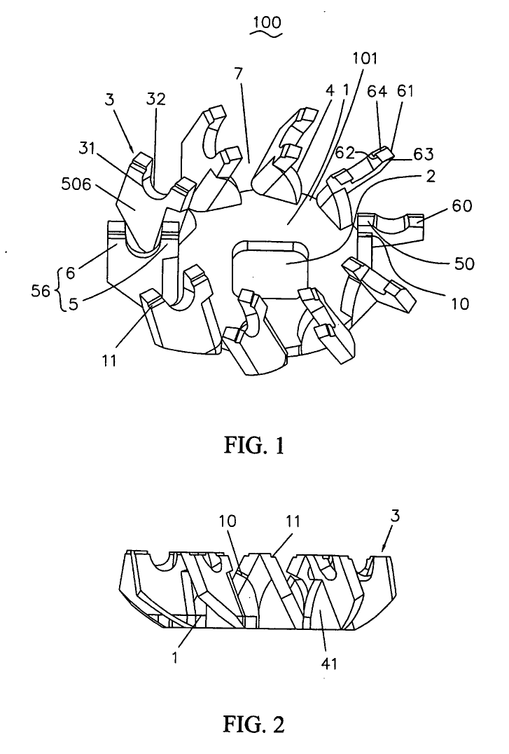

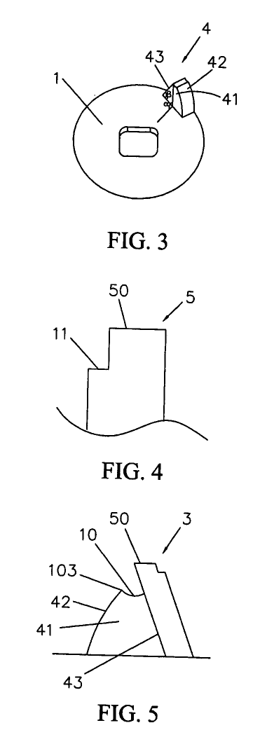

Referring to FIGS. 1 to 3, the cutting unit 100 in accordance with the present invention includes a circular cutter chassis 1 at the bottom thereof. A coupling aperture 2 is provided at the centre of the cutter chassis 1 in connection with a motor (not shown) for rotating the cutter chassis 1. Ten cutting members 3 in this Example are evenly distributed along a circumferential portion 101 of the circular cutter chassis 1. Each of the cutting members 3 comprises a pedestal 4 and a cutter 56 having an inner blade element 5 and an outer blade element 6. The pedestal 4 having a first inclined plane 43 extended upward from the cutter chassis 1, a second inclined plane 41 extended outward from the cutter chassis 1 and a curve surface 42, is mounted to the cutter chassis 1 along its circumferential portion 101. The cutter 56 in this Example has a U-configuration at the upper portion thereof, in which the inner blade element 5 and the outer blade element 6 form two arms, and a support 506 at the lower portion thereof to connect the pedestal 4 by means of the first inclined plane 43.

The plane that the pedestal 4 locates is perpendicular to the plane that the inner blade element 5 and the outer blade element 6 locate. The second inclined plane 41 of the pedestal 4 with the horizontal plane that the cutter chassis 1 locates forms an inclined angle α. The first inclined plane 43 of the pedestal 4 which is connected to the cutter 56 has an angle β with the plane the cutter chassis 1 locates. The pedestal 4 and the cutter 56 are substantially inclined outward from the cutter chassis 1.

The top surfaces 50 and 60 of the inner blade element 5 and the outer blade element 6 are in a square-shape and positioned on a same plane. The top surface 60 of the outer blade element 6 forms four blade edges 61, 62, 63, 64. So does the top surface 50 of the inner blade element 5. Moreover, fringes 31, 32 of the U-configuration are formed as edges of the cutting member 3. With such a configuration, the cutting unit 100 of the present invention can cut the whiskers in any directions and angles.

Two adjacent cutting members 3 form a slanting channel 7 for passing shaved whiskers.

In this Example, α is 95°, and β is 75°. The distance between the central lines of the inner blade element 5 and the outer blade element 6 in the longitudinal direction is 3 mm, and the distance between the central lines of the U-configuration cutting member 3 and the cutter chassis 1 is 7 mm, and the diameter of the cutter chassis 1 is 6 mm. Both the length and the width of each of the top surfaces 60 are 0.9 mm.

### EXAMPLE 2

In this Example, referring to FIGS. 1 and 4, a blade plane 11 is formed below the top surface 50 of the inner blade element 5 and adjacent to the upper side of the inner blade element 5. The blade plane 11 is parallel to the top surface 50. The distance between the top surface 50 and the blade plane 11 is 0.2 mm, the length of the blade plane 11 is 0.9 mm, and the width thereof is 0.1 mm. Other elements of the cutting unit are the same as in Example 1.

### EXAMPLE 3

In this Example, referring to FIG. 5, a semi-circular gap 10 is further provided at the upper joint of the pedestal 4 and the cutter 56. An edge 103 that can cut long whiskers enwinding around the cutter chassis 1 is formed on the joint of the gap 10 and the curve surface 42. The diameter of the gap 10 is 0.5 mm. Other elements of the cutting unit are the same as in Example 1 or Example 2.

It is understood that the particular structures embodying the present invention shown and described above are only used for illustrating the present invention, and are not intended to limit the invention. Any modifications or variations to the present invention without departing from the spirit of the invention shall be fallen into the scope of the invention defined by the appended claims.

What is claimed is:

1. A cutting unit for a shaver, comprising:
a circular cutter chassis having a coupling aperture provided at the center thereof; and
a plurality of cutting members evenly distributed along the circumference of the cutter chassis, each comprising:
a pedestal disposed at the circumference of the cutter chassis having a first inclined plane extended upward from the cutter chassis and a second inclined plane extended outward from the cutter chassis; and
a cutter connected to the first inclined plane and being perpendicular to the first inclined plane, having an inner blade element and an outer blade element relative to the center of the cutter chassis,
wherein the top surfaces of the inner blade element and the outer blade element are in a square-shape and positioned on a same plane.

2. The cutting unit of claim 1, wherein each of the inner blade element and the outer blade element has a blade plane which is disposed at the upper side thereof and parallel to the top surface thereof.

3. The cutting unit of claim 1, wherein a gap is formed at the upper joint of the pedestal and the cutter and said gap provides a blade edge at the upper end thereof.

4. The cutting unit of claim 2, wherein a gap is formed at the upper joint of the pedestal and the cutter and said gap provides a blade edge at the upper end thereof.

5. The cutting unit of claim 1, wherein each of the top surfaces of the inner blade element and the outer blade element has four blade edges.

6. The cutting unit of claim 2, wherein each of the top surfaces of the inner blade element and the outer blade element has four blade edges.

7. The cutting unit of claim 3, wherein each of the top surfaces of the inner blade element and the outer blade element has four blade edges.

8. The cutting unit of claim 4, wherein each of the top surfaces of the inner blade element and the outer blade element has four blade edges.

9. The cutting unit of claim 1, wherein the inner blade element and the outer blade element form a U-configuration and two fringes are formed at the joint thereof.

10. The cutting unit of claim 2, wherein the inner blade element and the outer blade element form a U-configuration and two fringes are formed at the joint thereof.

11. The cutting unit of claim 3, wherein the inner blade element and the outer blade element form a U-configuration and two fringes are formed at the joint thereof.

12. The cutting unit of claim 4, wherein the inner blade element and the outer blade element form a U-configuration and two fringes are formed at the joint thereof.

13. The cutting unit of claim 5, wherein the inner blade element and the outer blade element form a U-configuration and two fringes are formed at the joint thereof.

14. The cutting unit of claim 6, wherein the inner blade element and the outer blade element form a U-configuration and two fringes are formed at the joint thereof.

15. The cutting unit of claim 7, wherein the inner blade element and the outer blade element form a U-configuration and two fringes are formed at the joint thereof.

16. The cutting unit of claim 8, wherein the inner blade element and the outer blade element form a U-configuration and two fringes are formed at the joint thereof.

17. The cutting unit of claim 1, wherein the first inclined plane is disposed at an angle of 75° to less than 90° with the plane the cutter chassis locates, and the second inclined plane forms an angle of more than 90° to 95° with the plane the cutter chassis locates.

18. The cutting unit of claim 1, wherein the number of the cutting members is from 6 to 12, the distance between the central lines of the inner blade element and the outer blade element in the longitudinal direction is from 2 to 4 mm, both the length and width of each of the top surfaces of the inner blade elements and the outer blade elements are from 0.8 to 1 mm, the distance between the central lines of the cutting member and the cutter chassis in the longitudinal direction is from 4 to 10 mm, and the diameter of the cutter chassis is from 6 to 15 mm.

19. The cutting unit of claim 2, wherein the blade plane has a width of 0.1 to 0.5 mm in the circular direction, a depth of 0.1 to 0.5 mm in the longitudinal direction with respect to the top surface, and a length of 0.8 to 1 mm.

20. The cutting unit of claim 3, wherein the diameter of the gap is from 0.4 to 0.6 mm.
